(19) United States
(12) Patent Application Publication
(10) Pub. No.: US 2014/0203116 A1
(43) Pub. Date: Jul. 24, 2014

(54) Micro-Electronic Misting Device

(71) Applicant: Patricia Jean Wynn, Elburn, IL (US)

(72) Inventor: Patricia Jean Wynn, Elburn, IL (US)

(21) Appl. No.: 14/160,855

(22) Filed: Jan. 22, 2014

Related U.S. Application Data
(60) Provisional application No. 61/756,774, filed on Jan. 25, 2013.

(51) Int. Cl. B05B 5/025

(52) U.S. Cl. CPC B05B 5/0255
USPC 239/690

(57) ABSTRACT

The MICRO-ELECTRONIC MISTING DEVICE is an attachable/detachable portably powered sensor activated misting device. A mist is delivered from a nozzle apparatus once a distance and delay calibrated sensor module triggers a micro-electronic air/water pump motor. The sensor is activated by a user's proximity to the sensor. The configured sensor and motor pump apparatus sets inside a housing designed to fasten/twist onto common or specially designed containers.

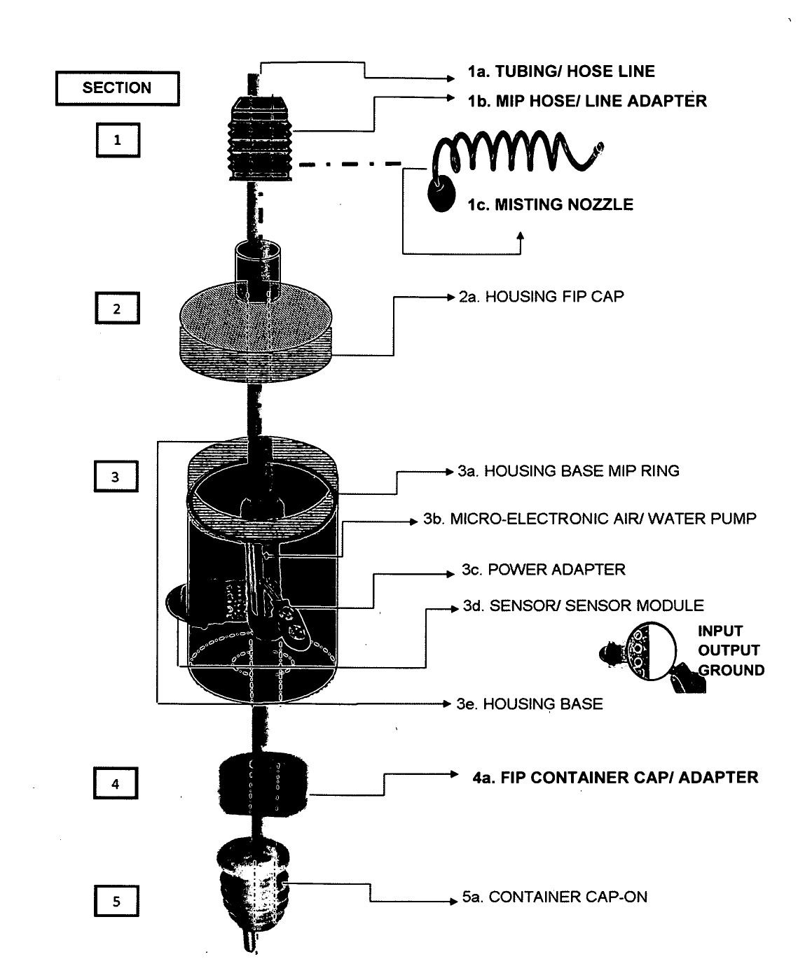

### CROSS-REFERENCE TO RELATED APPLICATIONS

Reference U.S.C. 119(e)—This application claims the benefit of the U.S. Provisional Application No. 61/756,774, filed Jan. 25, 2013

### SUMMARY

### Design/Pattern/Invention

1. As best as been ascertained through a legal assisted patent search review, nothing previously or currently similar in design, package, promotion, or patent exists as proposed; a small attachable/detachable portably powered sensor activated misting apparatus.
2. Components; exact and/or of slight variation, for the purpose of cost effectiveness or upgrades, are commonly found and purchased from either cyber or store front suppliers.
3. Components are easily assembled in a way as to trigger, produce, or transmit a mist by combined SENSOR/SENSOR MODULE, MOBIL/PORTABLE POWER (e.g. batteries, solar power, etc.) of 12v or less, MICRO-ELECTRONIC AIR/WATER PUMP MOTOR, TUBING, and MISTING NOZZLE APPARATUS and for external use only.
4. Components are assembled and then contained within a HOUSING; with a 1.0″ or smaller single port threaded MIP HOSE/LINE ADAPTER connection at one end and 1.0″ or smaller single port threaded FIP CONTAINER CAP/ADAPTER connection at the other; MIP connect for MISTING NOZZLE APPARATUS and FIP for ENCLOSURE/CONTAINER.
5. SENSOR/SENSOR MODULE is calibrated for distance and delay; when activated by a user's proximity it triggers the MICRO-ELECTRONIC AIR/WATER PUMP MOTOR to force liquid through the MISTING. NOZZLE APPARATUS; which produces the mist.

### Components:

### Power Adapter

Any variety capable of connecting, holding, and transferring 12 volts or less of MOBIL/PORTABLE POWER for the purpose of operating a SENSOR/SENSOR MODULE and MICRO-ELECTRONIC AIR/WATER PUMP MOTOR.

### Sensor/Sensor Module

Architecturally designed in such a way as to receive and connect to at least 12v of MOBIL/PORTABLE POWER by wire, modular clips (snaps), or soldering and output capacity for transferring power to operate a (12v or less) MICRO-ELECTRONIC AIR/WATER PUMP MOTOR. Most common SENSOR MODULES are architecturally designed for programmable functions; such as calibration for distance, sensitivity, duration of output, periodic and repetitive operation, etc.

### Micro-Electronic Air/Water Pump Motor

Require 12v or less of MOBIL/PORTABLE POWER to operate and designed in such a way as to connect (a) SENSOR/SENSOR MODULE by wire, modular clips (snaps), or soldering and (b) with inlet/outlet architecture for receiving TUBING/INLET/OUTLET HOSE APPARATUS connections. Pump no larger than what can fit within a HOUSING of 3.0″h×2.0″w×1.5″d for square encasements or 3.0″h×2.0″w for cylindrical. Pump motor must be of a design/pressure capacity as to force enough liquid through MISTING NOZZLE APPARATUS to create a mist; e.g. Windshield wiper pump avg. 300-400 psi.

### Housing

Of size, form, and material suitable enough to contain electronic components and allow for a 1.0″ or smaller single port MIP HOSE/LINE ADAPTER at one end for a MISTING NOZZLE APPARATUS connection and 1.0″ or smaller single port FIP CONTAINER CAP/ADAPTER at the other for a MIP FLANGE/NECK connection to a CONTAINER/ENCLOSURE. MIP and FIP adapter sizes adjust for common or specially designed ENCLOSURE/CONTAINERS.

### Tubing/Inlet/Outlet Hose Apparatus

Of size, form, and material (e.g. any line or aquarium hose for transporting air/liquids) necessary for attaching to MICRO-ELECTRONIC AIR/WATER PUMP MOTOR inlet/outlet connector architecture; whereby the INLET LINE is fed through a single port FIP CONTAINER CAP/ADAPTER and plastic CONTAINER CAP-ON for ENCLOSURE/CONTAINER placement and OUTLET LINE fed through a single port MIP HOSE/LINE ADAPTER for the MISTING NOZZLE APPARATUS connection. This apparatus is designed for the purpose of transporting liquids.

### Misting Nozzle Apparatus

Made up of short tube with a taper or constriction used to speed up or direct a flow of liquid and configured of suitable size, form, and function as to attach a HOSE and 1.0″ or smaller single port MIP HOSE/LINE ADAPTER for the purpose of creating a mist. Often affixed to the end of a tube and configured as a device which can be attached to ENCLOSURE/CONTAINERS. Style and/or adapter size adjust for common or specifically designed ENCLOSURE/CONTAINERS.

### Manufacturing Process and Design:

1. MOBIL/PORTABLE POWER connected to SENSOR/SENSOR MODULE via POWER ADAPTER, through wire, modular clips (snaps), or soldering.
2. SENSOR/SENSOR MODULE connected to MICRO-ELECTRONIC AIR/WATER PUMP MOTOR through output architecture of the SENSOR MODULE by modular clips (snaps), or soldering.
3. HOUSING enclosure assembled to scale for best enclosure and operation of the MICRO-ELECTRONIC AIR/WATER PUMP MOTOR, POWER ADAPTER, SENSOR/SENSOR MODULE, and MOBILE/PORTABLE POWER mechanism. Enclosures will be no larger than 3.0″h×2.0″w×1.5″d for square or 3.0″h×2.0″w for cylindrical encasement.
4. HOUSING is assembled in a way as to allow for a single port threaded MIP HOSE/LINE ADAPTER and single port threaded FIP CONTAINER CAP/ADAPTER to be affixed to exterior by threaded twist-on or bonding adhesive; for the purpose of connecting MISTING NOZZLE APPARATUS to the single port MIP HOSE/LINE ADAPTER and ENCLOSURE/CONTAINER's MIP FLANGE/NECK to the single port FIP CONTAINER CAP/ADAPTER. Single port MIP HOSE/LINE ADAPTER and single port FIP CONTAINER CAP/ADAPTER may vary in sizes less than 1.0″ diameter to adjust for common or specifically designed CONTAINER/ENCLOSURES.
5. HOUSING encases: a portion of the TUBING/INLET/OUTLET HOSE APPARATUS which connects to the INLET/OUTLET architecture of the MICRO-ELECTRONIC AIR/WATER PUMP MOTOR. MISTING NOZZLE APPARATUS is affixed to the end of the OUTLET HOSE; INLET HOSE extends to an ENCLOSURE/CONTAINER; by having been fed through a plastic CONTAINER CAP-ON within the neck of the container.
6. HOUSING made up of a HOUSING FIP CAP and HOUSING BASE with a threaded HOUSING BASE MIP RING affixed by threaded or bonding adhesive to its rim; which connects and twists on to the HOUSING FIP CAP; making the HOUSING unit accessible for switching out or recharging PORTABLE POWER.
7. When in use the SENSOR/SENSOR MODULE is activated by proximity to its user, the MICRO-ELECTRONIC AIR/WATER PUMP MOTOR pulls the liquid up through the INLET HOSE to the OUTLET HOSE forcing it through a MISTING NOZZLE APPARATUS; which creates the mist.

### Use:

MOBIL/PORTABLE POWER integrally connects to a distance and delay calibrated SENSOR/SENSOR MODULE which when activated by a user's proximity a MICRO-ELECTRONIC AIR/WATER PUMP MOTOR draws the contents of an ENCLOSURE/CONTAINER to a MISTING NOZZLE APPARATUS; at which point a fine mist is released. The HOUSING 1.0″ or smaller exterior FIP CONTAINER CAP/ADAPTER and MIP HOSE/LINE ADAPTER fasten/twist on feature is meant to allow for both convenience and ease of use. FIP AND MIP ADAPTER sizes of 1.0″ or less are for allowing attachment to common household handheld cleaning bottles and/or those specifically designed for the MICRO-ELECTRONIC MISTING DEVICE in order to create indoor and/or outdoor micro-tropical-like environments; such as for pets, botanicals, greenhouses, gardens, or other convenient external uses; etc.

### Benefits:

a. No comparable means currently exist and offer the convenience or functionality of the MICRO-ELECTRONIC MISTING DEVICE.
b. A user's proximity to a SENSOR/SENSOR MODULE activates the device to release a mist for external multi-purpose or refreshing micro rainforest/tropical-like use.
c. Tropical pet species; such as birds or reptiles can activate a mist by proximity to the SENSOR/SENSOR MODULE within their ENCLOSURE/CONTAINER niche environment; such as aquarium, atrium, greenhouse, or those specifically designed to operate with the MICRO-ELECTRONIC MISTING DEVICE etc.
d. Time constraints can make it difficult to consistently accommodate labor intensive functions; such as maintaining micro environments that keep tropical-type botanical and/or pet species healthy.
e. Vitamins for pets, plant food, or external use only substances (depending on functionality) that dissolve easily can be mixed within ENCLOSURE/CONTAINERS for misting.
f. Simple, convenient, and effective design can easily fasten/twist onto either most common household handheld cleaning ENCLOSURE/CONTAINERS or those specifically designed to work with the MICRO-ELECTRONIC MISTING DEVICE.
g. 1.0″ or smaller FIP CONTAINER CAP/ADAPTER or MIP HOSE/LINE ADAPTER connections adjust for common or specific use.
h. Small in size, easily portable, easy to use, operate, and runs on PORTABLE POWER; eliminating the need for wall sockets.

### BACKGROUND

1. An oath and declaration to the general design and concept of the invention was signed and witnessed prior to the findings of a patent search; which resulted in nothing of the like currently existing in patent form; original patent filing oath and declaration p. 13.
2. Creates a convenience and health benefit in its use for plants and animals in environments such as greenhouses, conservatories, atriums, aquariums, bird bath/showers, and with common household handheld cleaning sized containers for misting.
3. Separately each component is commonly used and can be purchased directly from suppliers.
4. There are no other misting devices currently configured to operate, in a similar fashion, with the listed components, and for the purposes being proposed by this invention.
5. Slight variations of components might deviate only to the extent that an alternative be more cost effective or improved to some degree or fashion; yet maintains consistency with the components listed herein and of original purpose and function.

### DEFINITIONS

Container Cap-On

Disposable and economical pour spout which fits in the neck of containers with caps; to help prevent evaporation and spills. When applicable, section of TUBING/INLET/OUTLET/HOSE APPARATUS.

Device

Electronic piece of equipment or a mechanism designed to serve a special purpose or perform a special function.

Enclosure/Container

Required for use of device but not included in the design/or manufacturing of the device. Bottle or reservoir meant to hold liquids such as for fountains, plants, greenhouses, conservatories, atriums, aquariums, bird bath/showers, spritzers, etc.

FIP Container Cap/Adapter

Female Iron Pipe (interior pipe threads for connections; plastics used mainly) CAP with a single port for feeding plumbing or aquarium hose/elbows/adapters etc. through and twisting onto compatible ENCLOSURE/CONTAINER MIPs; affixed to exterior of HOUSING by threaded twist-on or bonding adhesive.

Housing

Protective covering (as for a mechanical part or instrument) large enough for holding the following components: MICRO-ELECTRONIC AIR/WATER PUMP MOTOR, MOBIL/PORTABLE POWER, POWER ADAPTER, and SENSOR/SENSOR MODULE.

Housing FIP Cap

Cap threaded to twist/secure onto HOUSING MIP BASE RING.

Housing Base MIP Ring

Ring threaded to twist/secure onto HOUSING FIP CAP; affixed to exterior of HOUSING BASE by threaded twist-on or bonding adhesive.

Inlet Line

Section of TUBING/INLET/OUTLET HOSE APPARATUS whereby the direction of liquid is transported from ENCLOSURE/CONTAINER to the MICRO-ELECTRONIC AIR/WATER PUMP MOTOR via tube designed/configured for conveying liquids.

Micro-Electronic Air/Water Pump Motor

Small 12v (or less) MICRO-ELECTRONIC AIR/WATER PUMP MOTOR with precision inlet/outlet liquid metering and dispensing system and ability to connect to a POWER ADAPTER through wire, modular clips (snaps), or soldering.

MIP Hose/Line Adapter

Male Iron Pipe (exterior pipe threads for connections; plastics used mainly) with a single port for feeding plumbing or aquarium hose/elbows/adapters etc. through and twisting onto compatible MISTING NOZZLE APPARATUS FIPs; affixed to exterior of HOUSING FIP CAP by threaded twist-on or bonding adhesive.

Misting Nozzle Apparatus

Short tube with a taper or constriction used to speed up or direct a flow of liquid; often affixed to the end of a tube and configured as a device which can be attached to ENCLOSURE/CONTAINERS.

Mobile/Portable Power

Source of energy capable of being portable with the device it powers; such as batteries, solar power, and the like.

Outlet Line

Section of TUBING/INLET/OUTLET HOSE APPARATUS whereby the direction of liquid is transported from the MICRO-ELECTRONIC AIR/WATER PUMP MOTOR to the MISTING NOZZLE APPARATUS via tube designed/configured for conveying liquids.

Power Adapter

Component transfers energy from originating source of power to operate electronic device.

Sensor/Sensor Module

Device designed/programmed in a way as to respond to a physical stimulus (as energy, heat, light, sound, pressure, magnetism, or a particular motion) and transmit a resulting impulse (as for measurement or operating a control).

Tubing/Hose Line

Section of TUBING/INLET/OUTLET HOSE APPARATUS made up of the INLET and OUTLET LINES and designed/configured to convey liquids.

Tubing/Inlet/Outlet Hose Apparatus

Tube designed/configured for conveying liquids and made up of the INLET LINE, OUTLET LINE, and CONTAINER CAP-ON.

### DRAWINGS

### Figures

Section 1
[1a] TUBING/HOSE LINE
   Section of TUBING/INLET/OUTLET HOSE APPARATUS made up of the INLET and OUTLET LINES and designed/configured to convey liquids.
   Section of TUBING/INLET/OUTLET HOSE APPARATUS whereby the direction of liquid is transported from ENCLOSURE/CONTAINER up through a CAP-ON [5a.] to the MICRO-ELECTRONIC AIR/WATER PUMP MOTOR [3b.] to the MISTING NOZZLE APPARATUS [1c] via tube designed/configured for conveying liquids.
[1b] MIP HOSE/LINE ADAPTER
   Section of HOUSING FIP CAP [2a] of size, form, and material to twist/connect on to a MISTING NOZZLE APPARATUS FIPS [1c] and which features a single port to feed plumbing or aquarium hose/elbows/adapters etc. through; affixed to exterior of HOUSING FIP CAP [2a] by threaded twist-on or bonding adhesive. Adapter size adjusted for common or specially designed ENCLOSURE/CONTAINERS.
[1c] MISTING NOZZLE
   Section of MISTING NOZZLE APPARATUS; short tube with a taper or constriction used to speed up or direct a flow of liquid; often affixed to the end of a tube and/or configured as a device to be fastened for the purpose of creating a mist; in this case to a MIP HOSE/LINE ADAPTER [1b]; configurations to suit common and/or specially designed ENCLOSURE/CONTAINERS. Styles and/or adapter size adjust for common or specially designed ENCLOSURE/CONTAINERS.

Section 2
[2a] HOUSING FIP CAP
   Section of HOUSING threaded to twist onto HOUSING BASE MIP RING [3a] with a single port for feeding plumbing or aquarium hose/elbows/adapters etc. through.

Section 3
[3a] HOUSING BASE MIP RING
   Ring threaded to twist/secure onto HOUSING FIP CAP [2a]; affixed to exterior or rim of HOUSING BASE [3e] by threaded twist-on or bonding adhesive.
[3b] MICRO-ELECTRONIC AIR/WATER PUMP MOTOR
   Enclosed within HOUSING requiring no more than 12v of PORTABLE POWER to operate and designed in such a way as to receive and connect to the SENSOR/SENSOR MODULE [3d] by wire, modular clips (snaps), or soldering; Inlet/outlet architecture configured to connect with TUBING/INLET/OUTLET HOSE APPARATUS.
[3c] POWER ADAPTER
   Any variety capable of connecting, holding, and transferring 12 volts or less of MOBIL/PORTABLE POWER for the purpose of connecting to and operating a SENSOR/SENSOR MODULE [3d] and MICRO-ELECTRONIC AIR/WATER PUMP MOTOR [3b].
   MOBIL/PORTABLE POWER connects to POWER ADAPTER [3c] required for operation of device but not included in the sale/promotion/or manufacturing of the device; therefore not illustrated here.
[3d] SENSOR/SENSOR MODULE
   Architecturally designed in a way as to receive and connect to at least 12v of PORTABLE POWER via POWER ADAPTER [3c] by wire, modular clips (snaps), or soldering to and equipped with an output capable of transferring and triggering a (12v or less) MICRO-ELECTRONIC AIR/WATER PUMP [3b] to operate.
      Magnified section reveals INPUT, OUTPUT, and GROUND (order can vary) where POWER ADAPTER [3c] and MICRO-ELECTRONIC AIR/WATER PUMP [3b] are connected accordingly.
[3e] HOUSING BASE
   Section of HOUSING enclosure which acts to secure and protect the electronics of the device and which are assembled to enclose and facilitate the following components: MICRO-ELECTRONIC AIR/WATER PUMP MOTOR [3b], MOBIL/PORTABLE POWER, POWER ADAPTER [3c], and SENSOR/SENSOR MODULE [3d].
   Of size, form, and material suitable enough to contain electronic components and allow for a 1.0″ or smaller single port FIP CONTAINER CAP/ADAPTER [4a].

Section 4
[4a] FIP CONTAINER CAP/ADAPTER
   Section of HOUSING BASE [3e] for MIP FLANGE/NECK of CONTAINER/ENCLOSURE connections and of size, form, and material suitable enough to allow for a 1.0″ or smaller single port FIP CONTAINER CAP/ADAPTER to be affixed to exterior of HOUSING BASE [3e] by threaded twist-on or bonding adhesive; size to adjust for common or specifically designed containers.

Section 5
[5a] CONTAINER CAP-ON
   Section of TUBING/INLET/OUTLET HOSE APPARATUS placed in the neck of ENCLOSURE/CONTAINER and designed to help prevent evaporation and spills. INLET HOSE fed into ENCLOSURE/CONTAINER through CONTAINER CAP-ON.

1. Comprised of MICRO-ELECTRONIC MISTING DEVICE/COMPONENTS as follows:
a. POWER ADAPTER
b. SENSOR/SENSOR MODULE
c. MICRO-ELECTRONIC AIR/WATER PUMP MOTOR
d. MOBILE/PORTABLE POWER; required to operate but not included with device
e. HOUSING
f. TUBING/INLET/OUTLET HOSE APPARATUS
g. MISTING NOZZLE APPARATUS

2. Operates by following sequence:
a. Activated by users proximity to SENSOR/SENSOR MODULE
b. SENSOR/SENSOR MODULE signals operation of MICRO-ELECTRONIC AIR/WATER PUMP MOTOR
c. MICRO-ELECTRONIC AIR/WATER PUMP MOTOR transports liquid from INLET HOSE through OUTLET HOSE
d. From the OUTLET HOSE liquid is then forced through a MISTING NOZZLE APPARATUS to produce a fine mist
e. The device operates on functioning MOBIL/PORTABLE POWER

3. Functions to produce a mist for use with/or for, but not limited to, the following:
a. Indoor/or outdoor ENCLOSURE/CONTAINERS
b. Tropical/botanical ENCLOSURE/CONTAINERS
c. Indoor or Outdoor Bird baths ENCLOSURE/CONTAINERS
d. Common multi-purpose household handheld ENCLOSURE/CONTAINERS
e. ENCLOSURE/CONTAINERS designed specifically to connect with MICRO-ELECTRONIC MISTING DEVICE
f. As attachments to ENCLOSURE/CONTAINERS for placement inside or outside an aviary/tropical species contained niche; such as bird cages, aquariums, atriums, terrariums, etc.

4. Found to be unique from other misting device patents, however not exhaustive, in the following ways:
a. MICRO-ELECTRONIC MISTING DEVICE components are commonly found off the shelf and separately through either cyber/internet online or store front suppliers.
b. MICRO-ELECTRONIC MISTING DEVICE is activated by the user's proximity to a SENSOR/SENSOR MODULE; however control settings can be adapted.
c. MICRO-ELECTRONIC MISTING DEVICE components are enclosed within a FIP CONTAINER CAP/ADAPTER—MIP HOSE/LINE ADAPTER fasten/twist-on HOUSING for convenience and ease of use.
d. MICRO-ELECTRONIC MISTING DEVICE is a self-contained adaptable design that allows for being fastened/twisted onto multiple current or future containers and enclosures.
e. MICRO-ELECTRONIC MISTING DEVICE components have not been previously or currently assembled, packaged, presented, or patented in the configuration proposed.
f. MICRO-ELECTRONIC MISTING DEVICE components and configuration is not found to operate similarly to any other patented misting device.
g. MICRO-ELECTRONIC MISTING DEVICE is a small multi-adaptable MOBILE/PORTABLE POWERED misting device meant to be attached to multi-purpose or specifically designed ENCLOSURE/CONTAINERS.
h. MICRO-ELECTRONIC MISTING DEVICE is designed to create a refreshing micro rainforest/tropical-like environment for specifically designed or common household handheld multi-purpose containers.
i. MICRO-ELECTRONIC MISTING DEVICE is small, light, and easy to use, operate, tote, and runs on MOBILE/PORTABLE POWER.
